(19) United States
(12) Patent Application Publication
(10) Pub. No.: US 2009/0289859 A1
(43) Pub. Date: Nov. 26, 2009

(54) HYPERBAND ANTENNA AND PORTABLE WIRELESS COMMUNICATION DEVICE USING THE SAME

(75) Inventor: JUN-LIANG PAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/347,206

(22) Filed: Dec. 31, 2008

(30) Foreign Application Priority Data
May 21, 2008 (CN) 200810301695.1

(51) Int. Cl. H01Q 1/38; H01Q 1/24

(52) U.S. Cl. 343/702; 343/700 MS

(57) ABSTRACT

A planar hyperband antenna includes a feed end, a radiating body and a grounding end. The radiating body includes a main body, a first radiating arm, a second radiating arm and a third radiating arm. The first radiating arm, the second radiating, and the third radiating arm extend from the main body and share the feed end cooperatively. The radiating body generates three resonant frequencies according to the radio frequency signals received by the feed end to make the first radiating arm, the second radiating arm and the third radiating arm form three different operating frequencies.

### BACKGROUND

1. Technical Field

The present disclosure generally relates to antennas for portable wireless communication devices, particularly to a hyperband antenna which can provide multiple frequency bands and a portable wireless communication device using the hyperband antenna.

2. Discussion of the Related Art

With the developments of wireless communication and information processing technologies, portable wireless communication devices such as mobile phones and personal digital assistants (PDAs) are now in widespread use, and consumers may now enjoy the full convenience of high tech products almost anytime and anywhere. Typical portable wireless communication devices generally include a single band antenna assembled therein to transmit and receive electromagnetic waves. The single band antenna only allows transmission and receiving of only one frequency band for communication and does not provide the flexibility of using multiple frequency bands. A dual band antenna can solve the aforesaid problems. However, conventional dual band antennas are relatively large, and occupy a large space within portable wireless communication devices. Additionally, dual band antennas are not suitable for communicating systems providing more than two frequency bands.

Therefore, there is room for improvement within the art.

### BRIEF DESCRIPTION OF THE DRAWING

Many aspects of the present hyperband antenna and portable wireless communication device using the hyperband antenna can be better understood with reference to the following drawings. The components in the drawings are not necessarily drawn to scale, the emphasis instead being placed upon clearly illustrating the principles of the present the present hyperband antenna and a portable wireless communication device using the hyperband antenna. Moreover, in the drawings, like reference numerals designate corresponding parts throughout the several views.

FIG. 1 shows a schematic, perspective view of a hyperband antenna mounted on a circuit board of a portable wireless communication device, according to an exemplary embodiment.

FIG. 2 shows a schematic plane view of the hyperband antenna of FIG. 1.

FIG. 3 shows an exemplary test graph obtained from the hyperband antenna of FIG. 1, disclosing return loss varying with frequency.

### DETAILED DESCRIPTION

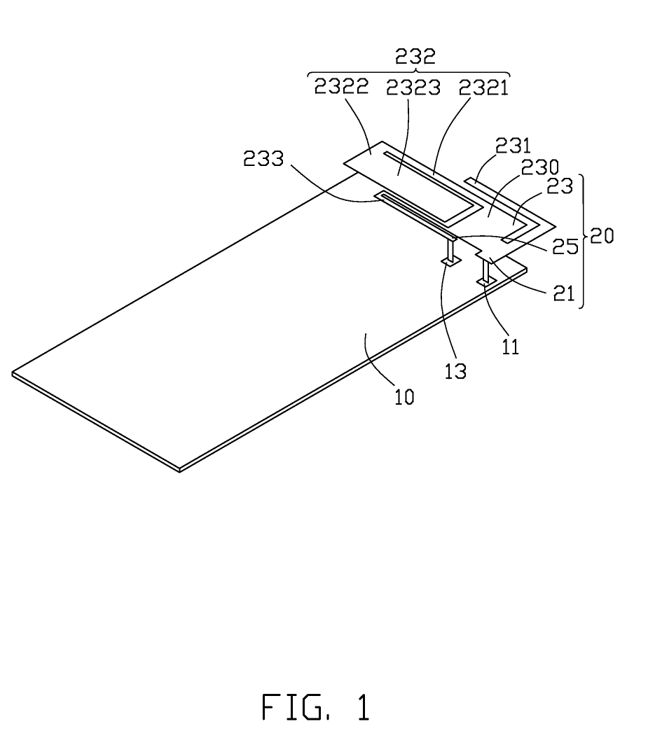

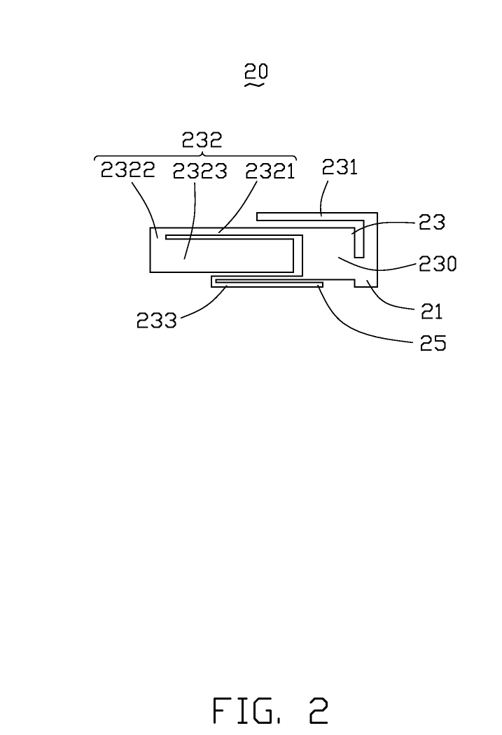

Referring to FIG. 1 and FIG. 2, a portable wireless communication device 100 according to an exemplary embodiment includes a circuit board 10 and a hyperband antenna 20 mounted on the circuit board 10. The circuit board 10 is substantially rectangular, and includes a signal incepting point 11 and a grounding point 13. The hyperband antenna 20 is a planar inverted F antenna (PIFA). The hyperband antenna 20 includes a feed end 21, a radiating body 23, and a grounding end 25. The radiating body 23 has a substantially rectangular sheet-shape and is mounted on, and in parallel with, the circuit board 10 adjacent one end of the circuit board 10. The feed end 21 and the grounding end 25 respectively electronically connect with the signal incepting point 11 and the grounding point 13 of the circuit board 10. In the present embodiment, the length of the radiating body 23 is about 50 mm and the width of the radiating body 23 is about 20 mm. The distance between the radiating body 23 and the circuit board 10 is about 5.6 mm. The feed end 21 is disposed at a corner of the radiating body 23 and electrically connects with the signal incepting point 11 of the circuit board 10 to feed and transmit radio frequency signals.

The radiating body 23 includes a main body 230, a first radiating arm 231, a second radiating arm 232, and a third radiating arm 233. The main body 230 has a substantially rectangular sheet-shape. One corner portion of the main body 230 is integrally formed with the feed end 21. The first radiating arm 231 is substantially an L-shaped plate extending from a conjoined portion of the main body 230 and the feed end 21, along a peripheral edge of the main body 230. The second radiating arm 232 is substantially a U-shaped plate extending from a corner of the main body 230 that is diagonally opposite to the corner from which the feed end 21 extends. The second radiating arm 232 includes a first arm portion 2321, a second arm portion 2322, and a third arm portion 2323. The first arm portion 2321 extends outwardly from the corner portion of the main body 230 that is diagonally opposite to the feed end 21. The second arm portion 2322 perpendicularly extends from a distal end of the first arm portion 2321 and towards the opposite edge of the circuit board 10. The third arm portion 2323 perpendicularly extends from the end of the second arm portion 2322 towards the main body 230. The width of the first arm portion 2321 is approximately equal to the width of the first radiating arm 231 and is smaller than the width of the third arm portion 2323. Thus, the open end of the U-shape of the second radiating arm 232 is toward the main body 230. The third radiating arm 233 is substantially a “U” shaped plate, and extends from the corner portion of the main body 230 opposite to the feed end 21, and is parallel to the second arm portion 2322. The open end of the U-shape of the third radiating arm 233 is toward the feed end 21. The width of the third radiating arm 233 is smaller than the width of the second radiating arm 232. The end of the third radiating arm 233 is spaced apart from the feed end 21. The grounding end 25 is at the end of the third radiating arm 233, and is electrically connected with the grounding point 13 of the circuit board 10.

When the hyperband antenna 20 is in use, the feed end 21 receives the outer signals and transmits the signals through the first radiating arm 231, the second radiating arm 232, and the third radiating arm 233 to form transmission routes of different lengths to operate at different frequencies for communication using GSM 850, GSM 900, DCS1800, PCS 1900, and UMTS 2100 communication systems. For example, signals transmitted through the second radiating arm 232 and the third radiating arm 233 are generated at an operating frequency that may work with GSM 850 and GSM 900 communication systems. Signals transmitted through the first radiating arm 231, the second radiating arm 232 and the third radiating arm 233 may be generated at an operating frequency that works with the DCS 1800 and the PCS 1900 communication systems. Signals transmitted through the first radiating arm 231 and the third radiating arm 233 may be generated at an operating frequency that works with the UMTS2100 communication system.

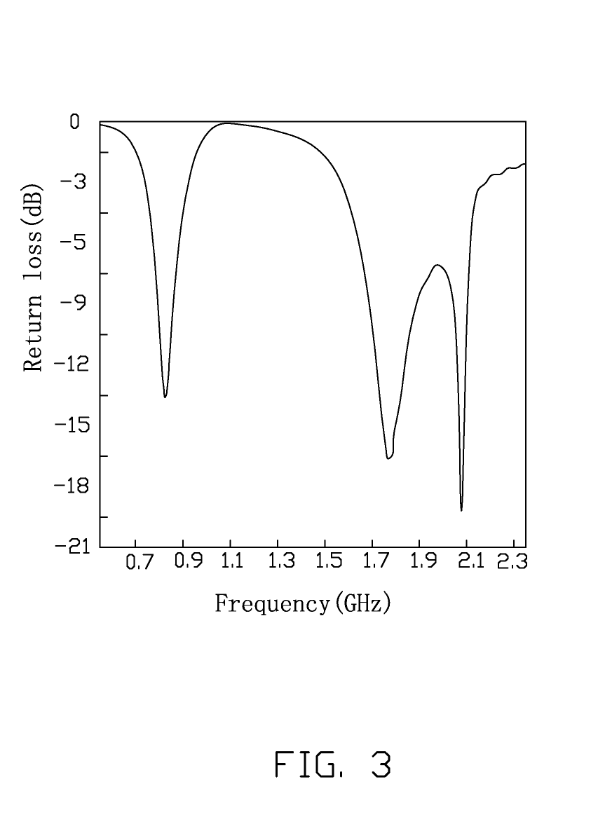

FIG. 3 shows an exemplary test graph of the hyperband antenna 20, disclosing return loss varying with frequency. The hyperband antenna 20 generates three resonant frequencies during the test. The three resonant frequencies include two high frequencies and a low frequency that increase the bandwidth of the working frequency of the hyperband antenna 20. According to FIG. 3, the bandwidth of the hyperband antenna 20 is suitable for working with GSM 850, GSM 900, DCS 1800, PCS 1900, and UMTS 2100 communication systems. When the hyperband antenna 20 operates at frequencies of 824 MHz, 960 MHz, 1710 MHz, and 2170 MHz, the return losses are about −6 dB, −3.82 dB, −6.89 dB and −5.4 dB respectively.

Finally, it is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A hyperband antenna for a portable wireless communication device, comprising:
a feed end receiving radio frequency signals;
a radiating body generating three resonant frequencies according to the radio frequency signals, comprising:
a main body;
a first radiating arm;
a second radiating arm; and
a third radiating arm; the first radiating arm, the second radiating arm, and the third radiating arm extending from the main body and sharing the feed end cooperatively; and
a grounding end at the end of the third radiating arm sharing the feed end.

2. The hyperband antenna as claimed in claim 1, wherein the main body has a rectangular sheet-shape having one corner portion integrally formed with the feed end; the main body and the feed end are at the same horizontal level; the first radiating arm is an L-shaped plate extending from the conjoined portion of the main body and the feed end along a peripheral edge of the main body.

3. The hyperband antenna as claimed in claim 2, wherein the second radiating arm is a U-shaped plate extending from the corner position of the main body opposite to the feed end; the second radiating arm is adjacent to the first radiating arm and at the same horizontal level with the first radiating arm.

4. The hyperband antenna as claimed in claim 3, wherein the second radiating arm includes a first arm portion, a second arm portion and a third arm portion; the first arm portion extends outwardly from the corner portion of the main body that is diagonally opposite to the feed end; the second arm portion perpendicularly extends from the distal end of the first arm portion; the third arm portion perpendicularly extends from the end of the second arm portion towards the main body; the open end of the second radiating arm towards the main body.

5. The hyperband antenna as claimed in claim 3, wherein the third radiating arm is a U-shaped plate extending from the corner portion of the main body opposite to the feed end and parallel to the second arm portion; the open end of the third radiating arm is towards the feed end.

6. The hyperband antenna as claimed in claim 4, wherein the width of the first arm portion is substantially the same as first radiating arm and smaller than the width of the third arm portion.

7. The hyperband antenna as claimed in claim 5, wherein the end of the third radiating arm is spaced apart from the feed end, the width of the third radiating arm is smaller than the second radiating arm; the grounding end is at the end of the third transmit arm.

8. The hyperband antenna as claimed in claim 1, wherein the hyperband antenna is a planar inverted F antenna.

9. A portable wireless communication device comprising:
a circuit board comprising a signal incepting point and a grounding point; and
a hyperband antenna mounted on, and in parallel with, the circuit board comprising:
a feed end electronically connecting with the signal incepting point for receiving radio frequency signals;
a radiating body generating three resonant frequencies according to the radio frequency signals, comprising:
a main body;
a first radiating arm;
a second radiating arm; and
a third radiating arm; the first radiating arm, the second radiating arm and the third radiating arm extending from the main body and sharing the feed end cooperatively; and
a grounding end at the end of the third radiating arm electronically connecting with the grounding point of the circuit board.

10. The portable wireless communication device as claimed in claim 9, wherein the main body has rectangular sheet-shape having one corner portion integrally formed with the feed end; the main body and the feed end are at the same horizontal level; the first radiating arm is an L-shaped plate extending from the conjoined portion of the main body and the feed end along a peripheral edge of the main body.

11. The portable wireless communication device as claimed in claim 10, wherein the second radiating arm is a U-shaped plate extending from the corner position of the main body opposite to the feed end; the second radiating arm is adjacent to the first radiating arm and at the same horizontal level with the first radiating arm.

12. The portable wireless communication device as claimed in claim 11, wherein the third radiating arm is a U-shaped plate extending from the corner portion of the main body opposite to the feed end and being at the same side; the open end of the third radiating arm is towards the feed end.

13. The portable wireless communication device as claimed in claim 9, wherein the hyperband antenna is a planar inverted F antenna.
